(19) United States
(12) Patent Application Publication
(10) Pub. No.: US 2018/0089207 A1
(43) Pub. Date: Mar. 29, 2018

(54) IMAGE TRANSFER APPARATUS AND METHOD

(71) Applicant: FUJITSU LIMITED, Kawasaki-shi (JP)

(72) Inventors: Kazuki Matsui, Kawasaki (JP); Tomoharu Imai, Kawasaki (JP)

(73) Assignee: FUJITSU LIMITED, Kawasaki-shi (JP)

(21) Appl. No.: 15/653,039

(22) Filed: Jul. 18, 2017

(30) Foreign Application Priority Data
Sep. 28, 2016 (JP) 2016-189157

(51) Int. Cl. G06F 17/30; G06F 17/21; G06F 17/22

(52) U.S. Cl. CPC G06F 17/3089; G06F 17/212; H04L 67/02; G06F 17/30864; G06F 17/2288

(57) ABSTRACT

In an image transfer apparatus, a storage unit holds a plurality of data groups each of which includes image data of a screen of a Web page displayed on a virtual browser, an address of the Web page, and setting information about display of the virtual browser performed when the image data is generated. An operation unit searches the data groups for a data group including an address matching an address of a Web page for which a browse request has been transmitted by a terminal apparatus and setting information matching setting information about the corresponding virtual browser. When a matching data group exists, the operation unit reads image data included in the data group from the storage unit and transmits the image data to the terminal apparatus.

### CROSS-REFERENCE TO RELATED APPLICATION

This application is based upon and claims the benefit of priority of the prior Japanese Patent Application No. 2016-189157, filed on Sep. 28, 2016, the entire contents of which are incorporated herein by reference.

### FIELD

The embodiments discussed herein relate to an image transfer apparatus and an image transfer method.

### BACKGROUND

In a known thin client technique, a client terminal performs minimum processing, and a server performs most processing. In particular, a screen-transfer-type thin client technique is widely used, in which a server performs processing and transfers a screen displaying an execution result of the processing to a client terminal as image data. For example, there has been proposed a system in which a client terminal is allowed to display a Web page by causing a server to operate a virtual browser and transmit image data of a screen of the virtual browser to the client terminal.

There has also been proposed a thin-client-type Web page browsing system in which a server holds cache data of a Web page and a compressed image of the Web page. In this system, the server acquires a Web page, for which a browse request has been transmitted by a terminal, from a Web server and determines whether the corresponding cache data of the acquired Web page exists. When the cache data exists, the server extracts the difference between the held image and the acquired Web page image and compresses only the image corresponding to the difference.

See, for example, Japanese Patent Laid-open Patent Publication Nos. 2015-32056 and 2012-252381.

In the above system in which a Web page is displayed by using the screen-transfer-type thin client technique, since the server generates image data of a screen of a Web page (this image data will hereinafter be referred to as “image data of a Web page”), it takes more time until the client terminal displays the Web page. This time could be shortened by caching the image data of the Web page and displaying a screen of the Web page on the basis of the cached image data when a link to this Web page is requested.

However, in the above system, the client terminal and the server do not exchange information for identifying the Web page, such as a uniform resource locator (URL). Thus, it is not possible for the client terminal to identify the Web page that needs to be displayed. Thus, in the above system, the method of caching an image data of a Web page is not applicable to the client terminal.

Even when the server is configured to cache image data of a Web page, the following problem arises. When image data of a Web page is cached, layout information about the characters or images on the Web page is not held. Thus, even when the same Web page is requested, when virtual browsers have different display environments, the virtual browsers could display the Web page differently.

For example, display environments of a virtual browser could be customized by an individual user or user group requesting to browse Web pages. Display environments of a virtual browser could be changed by updating of a program that realizes processing of the virtual browser. Thus, when cached image data is transmitted to a client terminal, the client terminal could display a screen of a Web page in a wrong way, namely, differently from the way the client terminal displays the screen of the Web page by using the current virtual browser.

### SUMMARY

According to one aspect, there is provided an image transfer apparatus including: a memory configured to hold at least one first data group, each of which includes first image data of a screen of a first Web page displayed on a virtual browser, a first address for identifying the first Web page, and first setting information about display of the virtual browser performed when the first image data is generated; and a processor configured to search the at least one first data group stored in the memory for a second data group including a first address matching a second address for identifying a second Web page for which a browse request has been transmitted by a terminal apparatus and first setting information matching second setting information about a virtual browser corresponding to the browse request for the second Web page, perform first processing when the second data group does not exist, and perform second processing when the second data group exists, wherein, in the first processing, the processor receives Web page information for displaying the second Web page from a server apparatus specified by the second address, generates second image data of a screen of the second Web page displayed on the virtual browser on the basis of the Web page information, and transmits the second image data to the terminal apparatus, and wherein, in the second processing, the processor reads first image data included in the second data group from the memory and transmits the first image data to the terminal apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a configuration example and a processing example of an image transfer system according to a first embodiment;

FIG. 2 illustrates a configuration example of a Web browsing system according to a second embodiment;

FIG. 3 illustrates a hardware configuration example of a browsing control gateway;

FIG. 4 illustrates Web page display control;

FIG. 5 is a block diagram illustrating a configuration example of processing functions of a terminal apparatus and the browsing control gateway;

FIG. 6 illustrates data examples stored in a container information storage unit;

FIG. 7 illustrates data examples stored in a cache;

FIG. 8 illustrates processing for registering a cache data set when a cache miss occurs;

FIG. 9 illustrates screen data registered in a cache data set;

FIG. 10 is a flowchart illustrating an example of processing performed when a link to a new Web page is requested by the terminal apparatus;

FIG. 11 illustrates a flowchart illustrating an example of processing performed by a cache gateway when a link to an external Web page is requested;

FIG. 12 is a flowchart illustrating an example of processing performed by a container started;

FIG. 13 is a flowchart illustrating an example of processing performed by the cache gateway when a cache miss is determined and a scroll operation is performed;

FIG. 14 is a flowchart illustrating an example of processing performed by the cache gateway when a cache hit is determined and a scroll operation is performed;

FIG. 15 is a flowchart illustrating an example of processing performed when a link to another external Web page is requested on an external Web page;

FIG. 16 illustrates data examples stored in the container information storage unit; and

FIG. 17 is a flowchart illustrating an example of processing performed when a link to an external Web page is requested.

### DESCRIPTION OF EMBODIMENTS

Hereinafter, embodiments will be described with reference to the accompanying drawings, wherein like reference characters refer to like elements throughout.

### First Embodiment

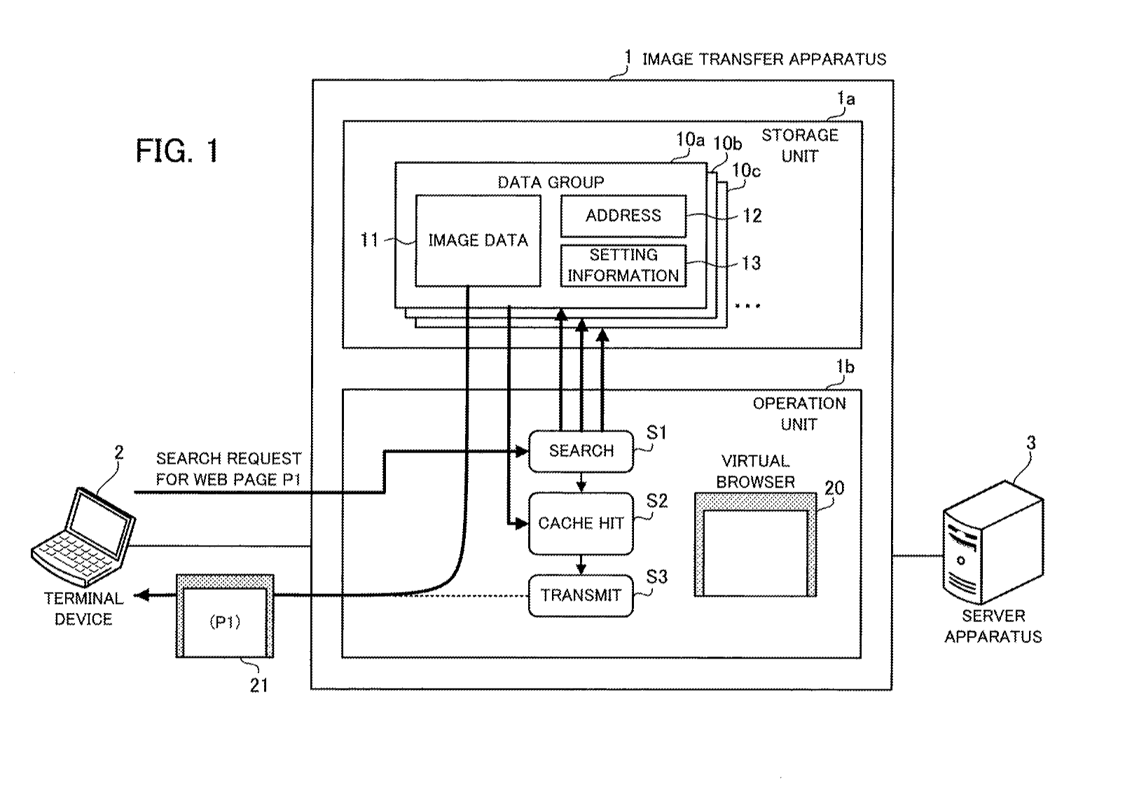

FIG. 1 illustrates a configuration example and a processing example of an image transfer system according to the first embodiment. This image transfer system illustrated in FIG. 1 includes an image transfer apparatus 1, a terminal apparatus 2, and a server apparatus 3.

The server apparatus 3 is a Web server that provides Web pages, and the terminal apparatus 2 is an apparatus used by a user to browse Web pages. Basically, the image transfer apparatus 1 generates image data of screens of Web pages transmitted by the server apparatus 3 and transmits the generated image data to the terminal apparatus 2. The terminal apparatus 2 displays screens based on the received image data. In this basic processing, instead of directly transferring data of a Web page transmitted by the server apparatus 3 to the terminal apparatus 2, the image transfer apparatus 1 transfers image data of a screen of the Web page to the terminal apparatus 2. Thus, the terminal apparatus 2 has improved security. For example, even when malware is transmitted by the server apparatus 3, the terminal apparatus 2 is prevented from being infected with the malware.

The image transfer apparatus 1 includes a storage unit 1a and an operation unit 1b. For example, the storage unit 1a is implemented as a storage area of a random access memory (RAM) of the image transfer apparatus 1. For example, the operation unit 1b is implemented as a processor of the image transfer apparatus 1.

The storage unit 1a holds data groups 10a, 10b, 10c, etc. In each of the data groups 10a, 10b, 10c, etc., image data 11, an address 12, and setting information 13 are registered. The storage unit 1a holds at least one data group.

The image data 11 in a data group is data of a screen of a certain Web page displayed on a virtual browser 20. This Web page is displayed when a browse request is transmitted by the terminal apparatus 2 or a different terminal apparatus. The virtual browser 20 is a function realized by processing of the operation unit 1b. Instead of the terminal apparatus 2, the virtual browser 20 receives data of a Web page from the server apparatus 3, interprets the received data, and displays the Web page on the screen of the virtual browser 20.

The address 12 in the data group is information for identifying a Web page corresponding to the image data 11. For example, the address 12 is a URL. The setting information 13 in the data group is setting information about display by the virtual browser 20 performed when the image data 11 is generated.

When the terminal apparatus 2 transmits a browse request for a certain Web page (hereinafter, “Web page P1”), the operation unit 1b performs processing as follows. The operation unit 1b searches the data groups 10a, 10b, 10c, etc. stored in the storage unit 1a for a data group which includes: an address 12 that matches an address for identifying the Web page P1; and setting information 13 that matches setting information about display by the virtual browser 20 performed when the browse request is transmitted (step S1).

While not illustrated in FIG. 1, there are cases in which no data group satisfying the above conditions exists (a cache miss). In such cases, the operation unit 1b receives Web page information for displaying the Web page P1 from the server apparatus 3 specified by the address for identifying the Web page P1. On the basis of the received Web page information, the operation unit 1b generates image data of a screen of the Web page P1 displayed on the virtual browser 20 and transmits the generated image data to the terminal apparatus 2. The terminal apparatus 2 displays the screen of the Web page P1 on the basis of the received image data.

In contrast, there are cases in which the operation unit 1b finds a data group satisfying the above conditions in the search in step S1 (a cache hit). As an example, the following description assumes that the operation unit 1b has found the data group 10a as a data group satisfying the above conditions (step S2). Next, the operation unit 1b reads the image data 11 included in the data group 10a from the storage unit 1a and transmits the image data 11 to the terminal apparatus 2 (step S3). The terminal apparatus 2 displays a screen 21 of the Web page P1 on the basis of the received image data 11.

In this way, when a cache hit occurs, the image transfer apparatus 1 does not generate the image data to be transmitted to the terminal apparatus 2 on the basis of Web page information. Thus, a cache hit takes a shorter time to display a screen of a Web page on the terminal apparatus 2 than a cache miss by the time needed by the image data generation processing.

In addition, the setting information 13 is also used as a retrieval key of the image data 11, in addition to the address 12. As a result, the screen of the Web page is displayed in an accurate format on the terminal apparatus 2 without disorder. For example, as in the present embodiment, when image data of a screen of a Web page is cached, layout information about the characters or images on the Web page is not held. Thus, even when the same Web page is requested, when the virtual browser 20 has a different display setting, the virtual browser 20 could display the Web page differently.

For example, the size or the aspect ratio of the Web page display area could differ depending on the number or the locations of images, such as menu items displayed on the virtual browser 20. In addition, when the size or the aspect ratio of the Web page display area differs, the locations of characters or images in the display area could change. In addition, display settings of the virtual browser 20 could change when a program that realizes processing of the virtual browser 20 is updated.

Through the processing in steps S1 to S3 performed by the operation unit 1b, the operation unit 1b determines whether a cache hit occurs in view of not only the difference among the Web pages identified by the addresses 12 but also the difference among the Web page display states of the virtual browser 20 based on the display settings. Thus, when a cache hit occurs, the terminal apparatus 2 is able to display a Web page in an accurate state, the Web page being the same as that displayed by using the current virtual browser 20.

Thus, the image transfer apparatus 1 allows the terminal apparatus 2 to accurately display a screen of a Web page within a short time.

### Second Embodiment

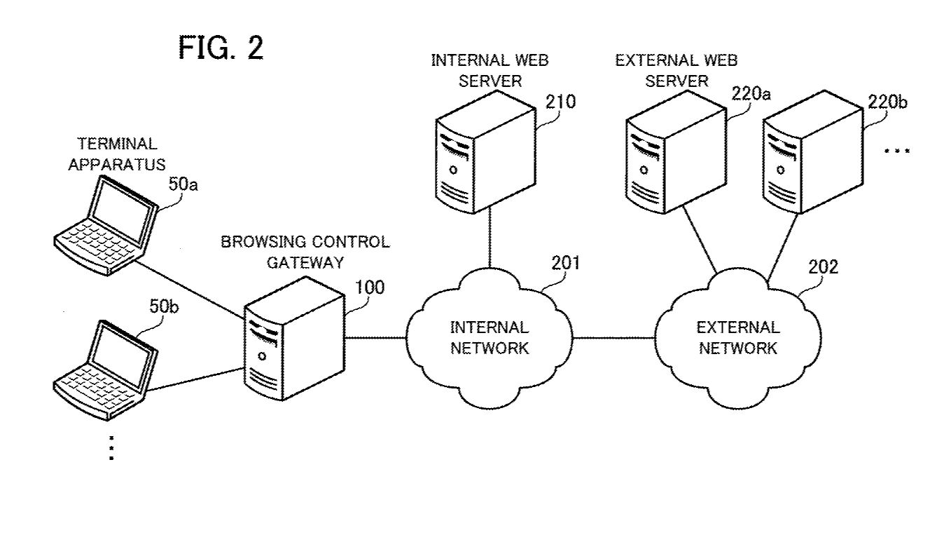

FIG. 2 illustrates a configuration example of a Web browsing system according to the second embodiment. The Web browsing system illustrated in FIG. 2 includes terminal apparatuses 50a, 50b, etc., a browsing control gateway 100, an internal Web server 210 connected to an internal network 201, and external Web servers 220a, 220b, etc. connected to an external network 202.

In this Web browsing system, users who operate the terminal apparatuses 50a, 50b, etc. are allowed to receive services provided by the internal Web server 210 and the external Web servers 220a, 220b, etc. via the browsing control gateway 100. The terminal apparatuses 50a, 50b, etc. access the Web servers via the browsing control gateway 100 and display Web pages provided by the Web servers on their respective browsers.

When any one of the terminal apparatuses accesses the internal Web server on the internal network 201, the browsing control gateway 100 directly transfers a HyperText Transfer Protocol (HTTP) response received by the internal Web server to the accessing terminal apparatus. This HTTP response includes various kinds of data for displaying a Web page on a browser, such as data of a HyperText Markup Language (HTML) document and data of an image on a requested Web page. In contrast, when a terminal apparatus accesses any one of the external Web servers on the external network 202, the browsing control gateway 100 causes the accessing terminal apparatus to display a requested Web page provided by the external Web server on the basis of a thin client method.

For example, the internal network 201 is a network established inside a company, and the external network 202 is a network established outside the company. For example, the browsing control gateway 100 determines whether a terminal apparatus is accessing the internal Web server or an external Web server on the basis of a domain name written as a host name in the corresponding URL specified as the access destination or an Internet Protocol (IP) address.

The internal Web server 210 and the external Web servers 220a, 220b, etc. receive input information from the terminal apparatuses via their respective Web pages and output processing results based on the input information to the terminal apparatuses by using the Web pages.

The Web browsing system may include any number of terminal apparatuses, internal Web servers, and external Web servers. When the terminal apparatuses 50a, 50b, etc. do not need to be distinguished from each other, any one of these terminal apparatuses will simply be referred to as a terminal apparatus 50, as needed. Likewise, when the external Web servers 220a, 220b, etc. do not need to be distinguished from each other, any one of these external Web servers will simply be referred to as an external Web server 220, as needed.

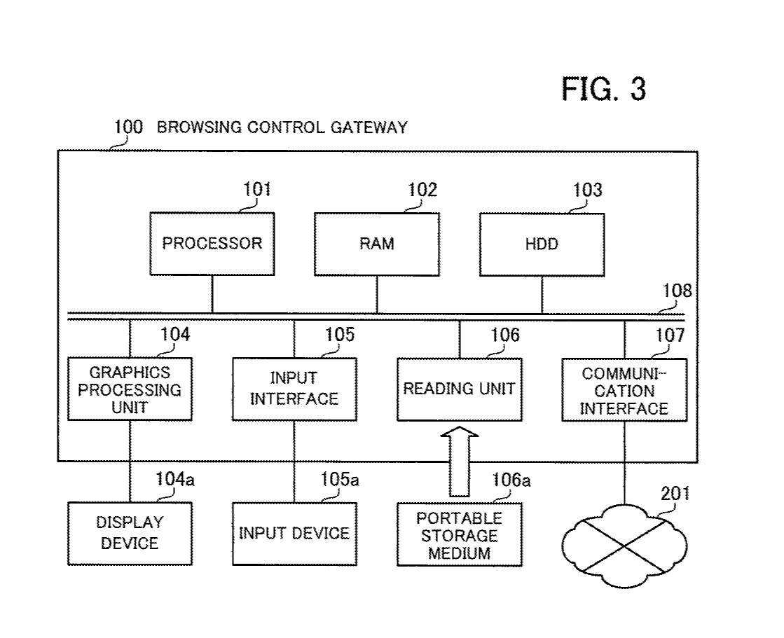

FIG. 3 illustrates a hardware configuration example of the browsing control gateway. For example, the browsing control gateway 100 is realized as a computer as illustrated in FIG. 3.

The browsing control gateway 100 is comprehensively controlled by a processor 101. The processor 101 may be a multiprocessor. Examples of the processor 101 include a central processing unit (CPU), a micro processing unit (MPU), a digital signal processor (DSP), an application specific integrated circuit (ASIC), a graphics processing unit (GPU), and a programmable logic device (PLD). Alternatively, the processor 101 may be a combination of at least two elements of a CPU, an MPU, a DSP, an ASIC, a GPU, and a PLD.

The processor 101 is connected to a RAM 102 and a plurality of peripheral devices via a bus 108.

The RAM 102 is used as a main storage device of the browsing control gateway 100. At least a part of an operating system (OS) program or an application program executed by the processor 101 is temporarily stored in the RAM 102. In addition, various kinds of data needed for processing performed by the processor 101 is stored in the RAM 102.

Examples of the peripheral devices connected to the bus 108 include a hard disk drive (HDD) 103, a graphics processing unit 104, an input interface 105, a reading unit 106, and a communication interface 107.

The HDD 103 is used as an auxiliary storage device of the browsing control gateway 100. OS programs, application programs, and various kinds of data are stored in the HDD 103. Another kind of non-volatile storage device such as a solid state drive (SSD) may be used as the auxiliary storage device.

The graphics processing unit 104 is connected to a display device 104a. The graphics processing unit 104 displays an image on a screen of the display device 104a in accordance with a command from the processor 101. The display device 104a may be a liquid crystal display, an organic electroluminescence (EL) display, or the like.

The input interface 105 is connected to an input device 105a. The input interface 105 transmits a signal outputted from the input device 105a to the processor 101. The input device 105a may be a keyboard, a pointing device, etc. Examples of the pointing device include a mouse, a touch panel, a tablet, a touchpad, and a track ball.

A portable storage medium 106a is attachable to the reading unit 106. The reading unit 106 reads data stored in the portable storage medium 106a and transmits the read data to the processor 101. Examples of the portable storage medium 106a include an optical disc, a magneto-optical disk, and a semiconductor memory.

The communication interface 107 is for exchanging data with other apparatuses such as the terminal apparatuses 50a, 50b, etc., the internal Web server 210, and the external Web servers 220a, 220b, etc.

The hardware configuration as described above realizes processing functions of the browsing control gateway 100. Each of the terminal apparatuses 50a, 50b, etc., the internal Web server 210, and the external Web servers 220a, 220b, etc. may be realized as a computer as illustrated in FIG. 3.

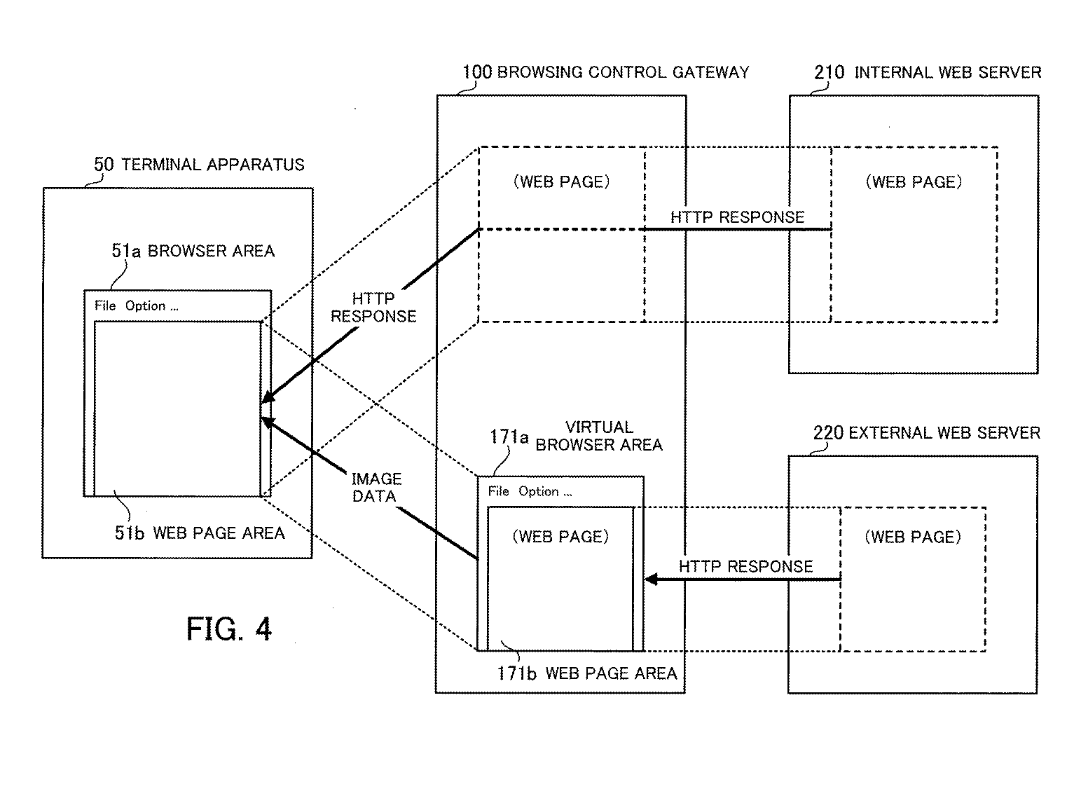

FIG. 4 illustrates Web page display control. The terminal apparatus 50 uses a browser to display a Web page. A browser area 51a illustrated in FIG. 4 is the entire display area of the browser, and a Web page area 51b displaying a Web page is arranged inside the browser area 51a.

In accordance with a user operation, the browser of the terminal apparatus 50 transmits an HTTP request specifying an access destination URL to the browsing control gateway 100. The browsing control gateway 100 refers to the received URL and determines whether the access destination is the internal Web server 210 or any one of the external Web servers 220.

When the access destination is the internal Web server 210, the browsing control gateway 100 directly transfers the received HTTP request to the access-destination internal Web server 210. In this case, as illustrated in the upper portion in FIG. 4, the browsing control gateway 100 directly transfers an HTTP response transmitted by the internal Web server 210 to the terminal apparatus 50. The browser of the terminal apparatus 50 generates a Web page image on the basis of the received HTTP response and displays the generated image in the Web page area 51b.

In contrast, when the access destination is any one of the external Web servers 220, the browsing control gateway 100 provides the terminal apparatus 50 with a Web page on the basis of a thin client method. More specifically, the browsing control gateway 100 starts a virtual browser. The virtual browser transmits the HTTP request specifying the access destination URL to the external Web server 220. In this case, as illustrated in the lower portion in FIG. 4, the virtual browser generates a Web page image on the basis of an HTTP response transmitted by the external Web server 220.

A virtual browser area 171a illustrated in FIG. 4 is the entire display area of the virtual browser, and a Web page area 171b displaying a Web page is arranged inside the virtual browser area 171a. The browsing control gateway 100 generates image data of an image displayed in the virtual browser area 171a, which includes the Web page area 171b in which an image of the generated Web page is displayed. Next, the browsing control gateway 100 transmits the generated image data to the terminal apparatus 50. The browser of the terminal apparatus 50 displays an image based on the received image data in the Web page area 51b. In this case, the image displayed in the Web page area 51b includes various images other than the image displayed in the Web page area 171b in the virtual browser area 171a. For example, menu items are also displayed in the Web page area 51b.

Thereafter, the browser of the terminal apparatus 50 and the browsing control gateway 100 perform processing for displaying a Web page in the Web page area 51b on the basis of a thin client method. Namely, the browser transmits operation information specifying user operations to the browsing control gateway 100, and the browsing control gateway 100 transmits image data of images in the Web page area 51b to the browser.

For example, when a user scrolls the Web page displayed in the Web page area 51b, the browser of the terminal apparatus 50 transmits operation information specifying the scroll operation to the browsing control gateway 100. The browsing control gateway 100 refers to the transmitted operation information and generates a scrolled image as the image to be displayed in the Web page area 171b. Next, the browsing control gateway 100 transmits the image data of the image in the virtual browser area 171a including the scrolled image to the terminal apparatus 50. The browser of the terminal apparatus 50 displays an image based on the received image data in the Web page area 51b. In this way, the scrolled Web page is displayed in the Web page area 51b.

In addition, for example, when a user selects a link on the Web page, the browser of the terminal apparatus 50 transmits position information specifying the selected position on the screen to the browsing control gateway 100. The virtual browser of the browsing control gateway 100 determines the selected link on the basis of the position information and transmits an HTTP request specifying the URL corresponding to the link to the external Web server 220. The virtual browser generates a Web page image on the basis of an HTTP response transmitted by the corresponding external Web server 220. The browsing control gateway 100 transmits image data of an image in the virtual browser area 171a including the generated image to the terminal apparatus 50.

As described above, when a user browses a Web page provided by the internal Web server 210, the browser of the terminal apparatus 50 displays the Web page on the basis of an HTTP response in a normal manner. In contrast, when a user browses a Web page provided by an external Web server 220, the browsing control gateway 100 blocks the data transmitted by the external Web server 220, converts the data into image data, and transmits the image data to the terminal apparatus 50. Namely, the data transmitted by the external Web server 220 is not directly received by the terminal apparatus 50. Thus, the terminal apparatus 50 has improved security. For example, the terminal apparatus 50 is prevented from being infected with malware included in data transmitted by an external Web server 220.

When a browser displays a Web page on the basis of a thin client method as described above, there is a problem that much delay time is caused between when the browser transmits an HTTP request and when the browser displays the Web page. This is because the browsing control gateway 100 needs extra processing time for generating image data of the Web page and transmitting this image data.

However, a technique for shortening the above delay time is known. In this technique, the data of a Web page is cached. However, generally, when a Web page is displayed on the basis of a thin client method, the display terminal does not recognize a URL. Thus, the display terminal does not determine the object that needs to be cached on the basis of a URL. Namely, the display terminal fails to cache any data of a Web page.

Thus, in the present embodiment, the browsing control gateway 100 is provided with a function of caching image data of Web pages provided by the external Web servers 220. When the browsing control gateway 100 holds image data of a Web page that needs to be transmitted to the terminal apparatus 50, the browsing control gateway 100 transmits the image data to the terminal apparatus 50, and the terminal apparatus 50 displays the corresponding Web page. Thus, the present embodiment needs a shorter delay time than the technique in which the browsing control gateway 100 receives an HTTP response about a Web page, generates image data of the Web page, and transmits the image data to the terminal apparatus 50.

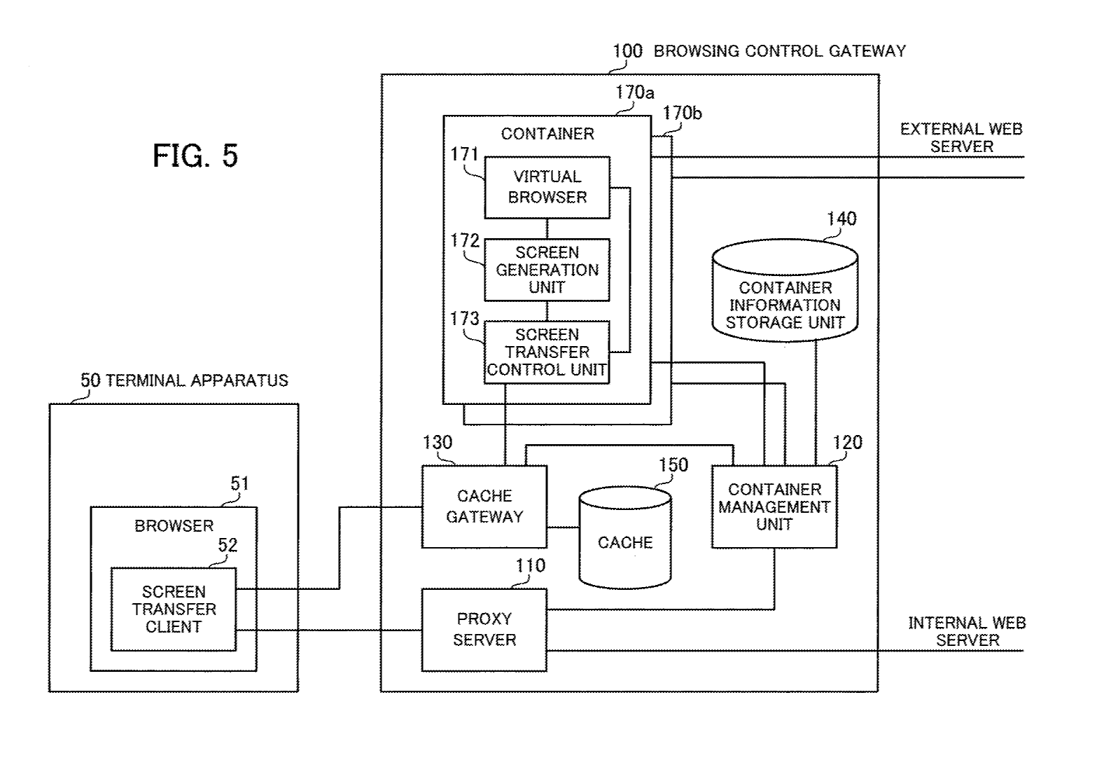

FIG. 5 is a block diagram illustrating a configuration example of processing functions of the terminal apparatus and the browsing control gateway.

The terminal apparatus 50 includes a browser 51 that displays Web pages. A processor of the terminal apparatus 50 executes a browser program to realize processing of the browser 51. In addition, the browser 51 includes a screen transfer client 52 that displays Web pages provided by the external Web servers 220 on the basis of a thin client method. A program that realizes processing of the screen transfer client 52 is supplied to the browser program as an add-on, for example.

The browsing control gateway 100 includes a proxy server 110, a container management unit 120, a cache gateway 130, a container information storage unit 140, and a cache 150. For example, the browsing control gateway 100 executes predetermined application programs to realize processing of the proxy server 110, the container management unit 120, and the cache gateway 130. For example, storage areas in storage devices of the browsing control gateway 100, such as the RAM 102 and the HDD 103, realize the container information storage unit 140 and the cache 150.

In addition, the container management unit 120 of the browsing control gateway 100 starts containers 170a, 170b, etc., each of which is a virtual user space provided by the browsing control gateway 100. These user spaces are provided as resource groups separated from each other so that application programs are executed. In the present embodiment, an individual memory space in the RAM 102 of the browsing control gateway 100 is allocated to each of the containers 170a, 170b, etc.

As illustrated in FIG. 5, each of the containers 170a, 170b, etc. realizes a virtual browser 171, a screen generation unit 172, and a screen transfer control unit 173. Namely, the processor 101 realizes the virtual browser 171, the screen generation unit 172, and the screen transfer control unit 173 of a container by executing application programs associated with the container by using a memory area allocated to the container.

In the present embodiment, for example, the containers 170a, 170b, etc. are generated for users or user groups who use the terminal apparatus 50, respectively. In the following description, when the containers 170a, 170b, etc. do not need to be distinguished from each other, any one of the containers will simply be referred to as a container 170, as needed.

When the proxy server 110 receives an HTTP request from the browser 51 of the terminal apparatus 50, the proxy server 110 extracts a URL specifying an access destination from the HTTP request. On the basis of the URL, the proxy server 110 determines whether the access destination is the internal Web server 210 or an external Web server 220.

When the access destination is the internal Web server 210, the proxy server 110 transmits the HTTP request to the internal Web server 210. Next, the proxy server 110 transfers an HTTP response transmitted by the internal Web server 210 to the browser 51 of the terminal apparatus 50. In contrast, when the access destination is an external Web server 220, the proxy server 110 transmits the URL to the container management unit 120. In this case, the communication for displaying an image on the browser 51 is performed between the screen transfer client 52 of the browser 51 and the screen transfer control unit 173 of a corresponding container 170 via the cache gateway 130.

By using a container-type virtualization technique, the container management unit 120 starts an individual container 170 and manages operations thereof. When the container management unit 120 receives the URL from the proxy server 110, the container management unit 120 starts a container 170 on the basis of the container information stored in the container information storage unit 140. The container management unit 120 selects a container 170 to be started on the basis of information about the user or user group using the terminal apparatus 50. The container management unit 120 transmits the URL to the started container 170 and causes the container 170 to generate a Web page image by using its virtual browser 171. In addition, the container management unit 120 notifies the cache gateway 130 of an identifier of the started container 170.

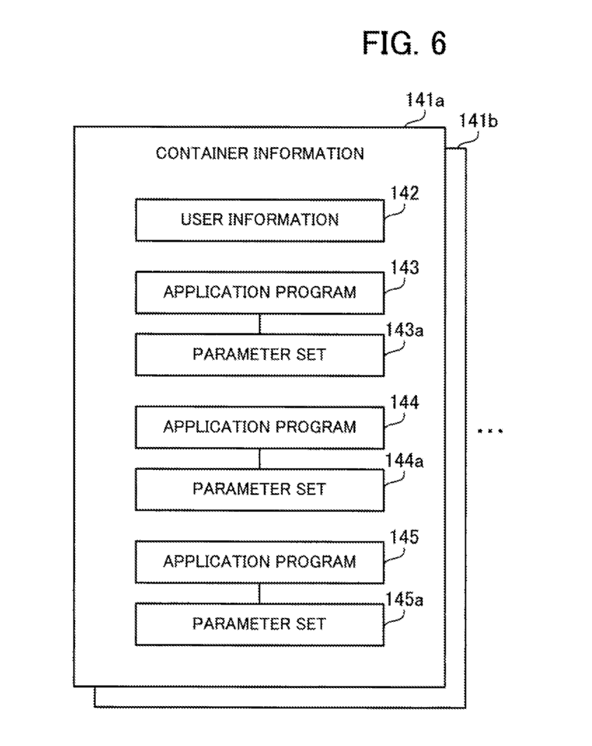

FIG. 6 illustrates data examples stored in the container information storage unit. The container information storage unit 140 holds container information 141a, 141b, etc. for starting the respective containers 170. The items of container information 141a, 141b, etc. each include user information 142, application programs 143, 144, and 145, and parameter sets 143a, 144a, and 145a.

An individual item of user information 142 includes information specifying a user associated with the corresponding container 170. For example, when an individual container 170 is started per user or user group, identification information about the corresponding user or user group or an address of the terminal apparatus used by the corresponding user or user group is registered in the corresponding user information 142.

The application programs 143, 144, and 145 are examples of programs executed in the resource space allocated to the corresponding container 170. One of these programs is a program (a virtual browser program) that realizes processing of the corresponding virtual browser 171. In addition, examples of these programs include programs that realize processing of the screen generation unit 172 and the screen transfer control unit 173.

Each of the parameter sets 143a, 144a, and 145a is a group of attribute information and setting values about the corresponding one of the application programs 143, 144, and 145. The setting values are set for setting items specifying an environment in which the corresponding one of the application programs 143, 144, and 145 is executed. For example, a parameter set corresponding to a virtual browser program includes attribute information such as version information about the virtual browser program and setting values set for various setting items about display of a screen on the corresponding virtual browser 171. For examples, on the basis of some of these setting items, the container management unit 120 sets whether to display each of a plurality of menu items that may be displayed on the screen of the virtual browser 171.

While an individual item of container information illustrated in FIG. 6 includes three application programs and three parameter sets, the container information may include any number of application programs and parameter sets.

The following description will be made with reference to FIG. 5 again.

The virtual browser 171 of the started container 170 notifies the cache gateway 130 of the URL of the access destination and the parameter set about the virtual browser 171 acquired from the container management unit 120 via the screen transfer control unit 173. In addition, the virtual browser 171 transmits the HTTP request specifying the acquired URL to the requested external Web server 220 and receives an HTTP response from the external Web server 220. The virtual browser 171 interprets the data included in the HTTP response and causes the screen generation unit 172 to generate a Web page image.

The screen generation unit 172 generates image data of a Web page image in accordance with an instruction from the virtual browser 171. In this operation, on the basis of the setting information about the virtual browser 171, the screen generation unit 172 generates image data of an image displayed in the virtual browser area 171a including a Web page image displayed in the Web page area 171b.

When the cache gateway 130 determines a cache miss, the screen transfer control unit 173 transmits the image data generated by the screen generation unit 172 to the screen transfer client 52 of the terminal apparatus 50 via the cache gateway 130. In contrast, when the cache gateway 130 determines a cache hit, the screen transfer control unit 173 compares the image displayed in the Web page area 171b based on the cached image data with the image displayed in the Web page area 171b based on the image data generated by the screen generation unit 172. The screen transfer control unit 173 detects the difference between the images and transmits information about the difference to the cache gateway 130.

The cache gateway 130 performs control on the caching of Web pages between the screen transfer control unit 173 and the screen transfer client 52 of the terminal apparatus 50. More specifically, the cache gateway 130 determines whether image data of a requested Web page is stored in the cache 150. When the image data is stored in the cache 150 (a cache hit), the cache gateway 130 transmits this image data to the screen transfer client 52 of the terminal apparatus 50, instead of the image data transmitted by the screen transfer control unit 173. However, when the image data is not stored in the cache 150 (a cache miss), the cache gateway 130 transmits the image data transmitted by the screen transfer control unit 173 to the screen transfer client 52 of the terminal apparatus 50.

When the terminal apparatus 50 as the communication peer ends the browsing of the Web page provided by the external Web server 220, the started container 170 is deleted from the browsing control gateway 100. For example, the memory area corresponding to the container 170 is deleted from the RAM 102. Namely, the browsing control gateway 100 is configured so that the data used in the processing performed on the container 170 will not permanently remain. Configured in this way, the browsing control gateway 100 has improved security. For example, the possibility that the browsing control gateway 100 could be infected with malware transmitted by an access-destination external Web server 220 is reduced.

However, because of this configuration, even when a virtual browser 171 on a container 170 is provided with a Web page cache function, when the container 170 is deleted, the cached data is also deleted. Thus, the virtual browsers 171 fails to be provided with a Web page cache function.

However, in the present embodiment, the cache gateway 130 and the cache 150 are arranged outside the containers 170. In this way, even after a container 170 corresponding to a virtual browser 171 is deleted, the browsing control gateway 100 is able to hold the data of a Web page displayed on the virtual browser 171. In addition, any containers 170 started subsequently are able to share the held data.

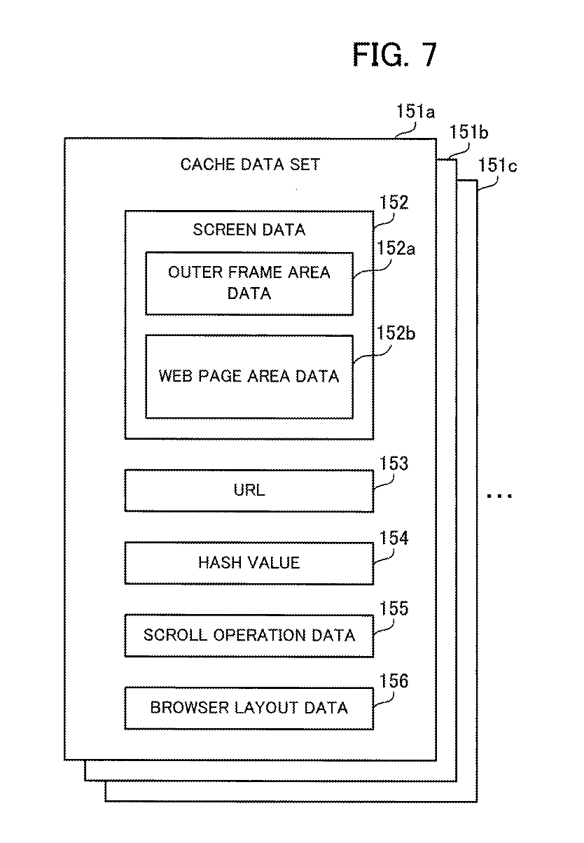

FIG. 7 illustrates data examples stored in the cache. Cache data sets 151a, 151b, 151c, etc. are stored in the cache 150. Each of the cache data sets 151a, 151b, 151c, etc. includes screen data 152, a URL 153, a hash value 154, scroll operation data 155, and browser layout data 156. In the following description, when the cache data sets 151a, 151b, 151c, etc. do not need to be distinguished from each other, any one of these cache data sets will be referred to as a cache data set 151, as needed.

The screen data 152 in a cache data set 151 is data for displaying an image on the browser 51 of the terminal apparatus 50. The screen data 152 includes: outer frame area data 152a for displaying an image in an outer frame area of the corresponding virtual browser 171; and Web page area data 152b for displaying an image in the Web page area 171b.

The URL 153 in the cache data set 151 is an address specifying the destination accessed when the image corresponding to the screen data 152 is generated.

The hash value 154 in the cache data set 151 is a hash value calculated on the basis of at least one parameter set about the corresponding container 170 including the corresponding virtual browser 171 that displays the image corresponding to the screen data 152. This parameter set includes at least a value of a setting item about a display state of the corresponding virtual browser 171. The present embodiment assumes that the hash value 154 is calculated on the basis of a parameter set corresponding to the virtual browser program that realizes the processing of the corresponding virtual browser 171 among the parameter sets included in the container information (for example, among the parameter sets 143a, 144a, 145a in FIG. 6). The hash value 154 is calculated by using a hash function called Secure Hash Algorithm 1 (SHA-1), for example.

The URL 153 and the hash value 154 are items of information used for determining whether the corresponding screen data 152 represents an image that needs to be displayed by the browser 51 of the terminal apparatus 50.

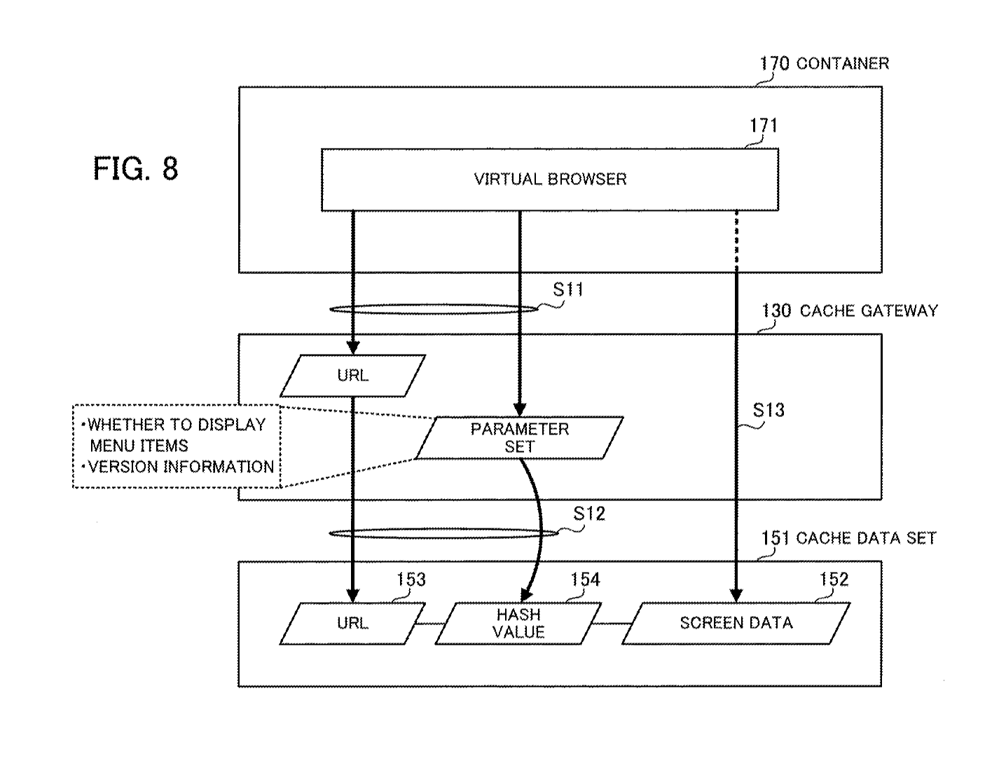

FIG. 8 illustrates processing for registering a cache data set when a cache miss occurs. When the terminal apparatus 50 requests a link to a Web page of an external Web server 220, the cache gateway 130 acquires the URL of the link destination and the parameter set about the virtual browser 171 of the corresponding container 170 from the virtual browser 171 via the screen transfer control unit 173 (step S11). The cache gateway 130 calculates a hash value on the basis of the acquired parameter set and searches the cache 150 for a cache data set 151 in which the acquired URL and the calculated hash value are registered.

When the matching cache data set is not registered in the cache 150 (a cache miss), the cache gateway 130 creates a cache data set 151 including the acquired URL and the calculated hash value and registers the created cache data set 151 in the cache 150 (step S12). Next, the cache gateway 130 transmits data for displaying a Web page image based on an HTTP response received by the virtual browser 171 to the terminal apparatus 50 and registers the image data in the created cache data set 151 (step S13). In this operation, the cache gateway 130 registers not only the Web page area data 152b corresponding to the Web page image but also the outer frame area data 152a displaying the image in the outer frame area of the virtual browser 171 in the cache data set 151.

In contrast, while not illustrated, there are cases in which the matching cache data set 151 is registered in the cache 150 (a cache hit). In such cases, the cache gateway 130 transmits the screen data 152 extracted from the cache data set 151 to the terminal apparatus 50. Namely, the browser 51 of the terminal apparatus 50 is able to display a Web page image, without having to wait for completion of the reception of an HTTP response and the generation of a Web page image by a virtual browser 171. Thus, the browser 51 is able to display Web pages of external Web servers 220 more quickly.

As described above, the cache gateway 130 registers a URL 153 indicating an access destination and a hash value 154 based on a parameter set in a cache data set in the cache 150. The parameter set used to calculate the hash value includes values of setting items about a display state of the corresponding virtual browser 171 that performs Web page display processing. Since this data is used to search for the corresponding screen data 152, when a cache hit is determined, the Web page in the virtual browser area 171a is accurately displayed in the Web page area 51b of the browser 51.

As described with reference to FIG. 4, when the terminal apparatus 50 displays a Web page of an external Web server 220, the Web page area 51b displays the image in the virtual browser area 171a including the Web page image in the Web page area 171b. Thus, when the cache gateway 130 searches the cache 150, even when a cache data set 151 having a matching URL 153 exists, if a setting value about the virtual browser 171 used to generate the corresponding held image is different, the image is displayed differently.

For example, menu items for receiving various operations are displayed in the upper area of the outer frame area in the virtual browser area 171a. Examples of these menu items include those used for setting and browsing information, such as “File,” “Option,” and “Help.” The parameter set about a virtual browser 171 includes a setting item for setting whether to display such a menu item in the outer frame area. When a setting value of such a setting item differs, information displayed in the outer frame area also differs. In some cases, the size of the outer frame area itself could also differ. Thus, even when the cache gateway 130 finds screen data 152 associated with the target URL 153 in the cache data set 151, if the hash value 154 differs, the image displayed in the Web page area 51b of the browser 51 based on the screen data 152 differs.

In addition, the hashed parameter set includes a version number of the virtual browser program. For example, a virtual browser program included in container information could be updated to a new version by processing of the container management unit 120. In this case, what is displayed in the virtual browser area 171a on the basis of the virtual browser program of the new version could be changed. For example, a menu item as described above could be changed or the way in which an individual menu item is displayed could be changed.

In the present embodiment, a hash value 154 based on a parameter set as described above is used as a retrieval key in the cache 150. In this way, when a cache hit is determined and when the corresponding image is displayed in the Web page area 51b of the browser 51 on the basis of the corresponding screen data 152 held in the cache 150, the Web page is accurately displayed in the same way as that displayed by using the virtual browser 171.

Other than the above setting items, the following setting items could be included in the hashed parameter set. For example, setting items for setting whether to display a status bar, a favorite bar, and a command bar that may be displayed in the outer frame area of the virtual browser area 171a could be included in the hashed parameter set. In addition, setting items for setting the text color, the background color, and the font type could be included in the hashed parameter set. In addition, setting items for setting whether to display an image and a line under a link and whether to use smoothed scroll could be included in the hashed parameter set. In addition, a setting item for setting the layout of the outer frame area could be included in the hashed parameter set.

The following description will be made with reference to FIG. 7 again.

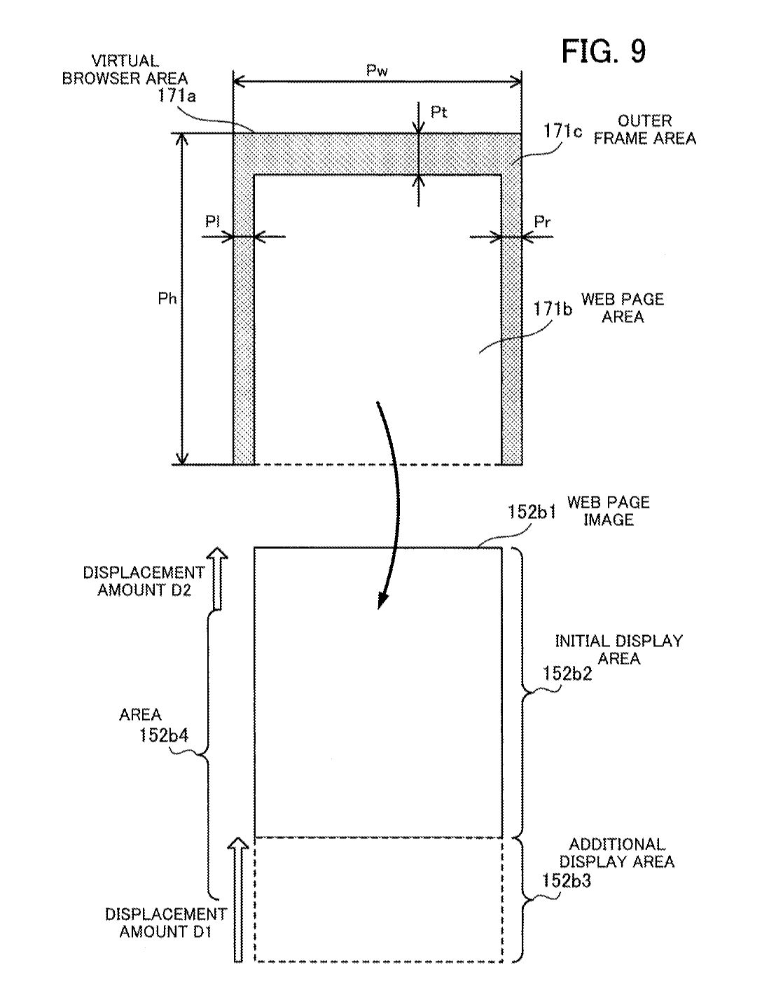

The scroll operation data 155 specifies screen scroll operations inputted by the terminal apparatus 50 when a Web page of an external Web server 220 is displayed. As will be described in detail with reference to FIG. 9, the Web page area data 152b could include, in addition to initial screen data for displaying the Web page displayed first by the virtual browser 171, screen data additionally displayed when a scroll operation is performed. In this case, the cache gateway 130 is able to generate image data corresponding to the scrolled Web page and transmits the generated image data to the terminal apparatus 50 by using the Web page area data 152b and the scroll operation data 155.

The browser layout data 156 is setting data about the outer frame area in the virtual browser area 171a. When the cache gateway 130 generates an image to be transmitted to the terminal apparatus 50 on the basis of a cache data set 151, the cache gateway 130 refers to the corresponding browser layout data 156. It is desirable that the browser layout data 156 be included in the parameter set used to calculate the corresponding hash value 154.

FIG. 9 illustrates screen data registered in a cache data set. The cache gateway 130 divides the image data displayed by a virtual browser 171 and generated by the corresponding screen generation unit 172 into the outer frame area data 152a and the Web page area data 152b and registers these images in the cache data set 151.

The outer frame area data 152a is the image data in the outer frame area 171c of the virtual browser area 171a, namely, the image data in the area other than the Web page area 171b. The outer frame area 171c is hatched in FIG. 9. For example, the above menu item display area is included in the outer frame area 171c.

In addition, the browser layout data 156 included in the cache data set 151a is setting data about the layout of the outer frame area 171c. For example, the browser layout data 156 includes pixel numbers Pw, Ph, Pt, Pl, and Pr. The pixel number Pw represents the number of pixels in the horizontal direction of the outer frame area 171c. The pixel number Ph represents the number of pixels in the vertical direction of the outer frame area 171c. The pixel number Pt represents the vertical width of the upper area of the outer frame area 171c. For example, this upper area could include the menu item display area. The pixel number P1 represents the horizontal width of the left-side area of the outer frame area 171c. The pixel number Pr represents the horizontal width of the right-side area of the outer frame area 171c.

The Web page area data 152b is data in a Web page image 152b1 displayed in the Web page area 171b. This Web page image 152b1 includes at least an image in an initial display area 152b2 displayed in the Web page area 171b when display of a Web page is started. When the virtual browser 171 displays a Web page, the cache gateway 130 first acquires image data in the outer frame area 171c and image data in the initial display area 152b2 displayed in the Web page area 171b. The cache gateway 130 registers, in the cache data set 151, the former image data as the outer frame area data 152a and the later image data as the Web page area data 152b.

In addition, when a scroll operation is performed on the terminal apparatus 50, the virtual browser 171 shifts the Web page image displayed in the Web page area 171b downward by the corresponding scroll displacement amount. As a result, a new image under the Web page area 171b is additionally displayed. For example, as illustrated in FIG. 9, when a scroll operation with a displacement amount D1 is performed, an image in an additional display area 152b3 having the same vertical width as the displacement amount D1 is additionally displayed in the Web page area 171b.

In this case, the cache gateway 130 acquires the image data in the additional display area 152b3, includes the acquired image data in the Web page area data 152b, and registers the combined data. In addition, the cache gateway 130 additionally registers information (pixel number) about the displacement amount D1 in the cache data set 151a as the scroll operation data 155.

In this way, after a cache hit is determined and the cache gateway 130 causes the browser 51 to display an image by using the screen data 152 in a cache 150, even when a scroll operation is performed, the cache gateway 130 could cause the browser 51 to continuously display an image by using the screen data 152. For example, when a cache hit is determined, the cache gateway 130 extracts the image in the initial display area 152b2 from the Web page image 152b1 and causes the browser 51 to display the image.

Next, for example, when a scroll operation is performed with a displacement amount D2 (D2≦D1), the cache gateway 130 extracts an image in an area 152b4 by shifting the initial display area 152b2 in the Web page image 152b1 downward by the displacement amount D2 and causes the browser 51 to display the resultant image. In this operation, which position in the horizontal direction of the Web page image 152b1 is used as the extraction position is determined from the pixel numbers Ph and Pt included in the browser layout data 156 and the displacement amount by the scroll operation.

As described above, when a scroll operation is performed on the terminal apparatus 50, the browsing control gateway 100 could cause the browser 51 to continuously display the corresponding Web page by using the corresponding screen data 152 stored in the cache 150. As a result, the cache hit ratio is improved, and a faster response to a scroll operation is achieved while a user is browsing a Web page of an external Web server 220.

Next, processing performed by the browsing control gateway 100 will be described with reference to a flowchart. In the following description, a Web page provided by the internal Web server 210 will be referred to as an internal Web page, and a Web page provided by any one of the external Web servers 220a, 220b, etc. will be referred to as an external Web page.

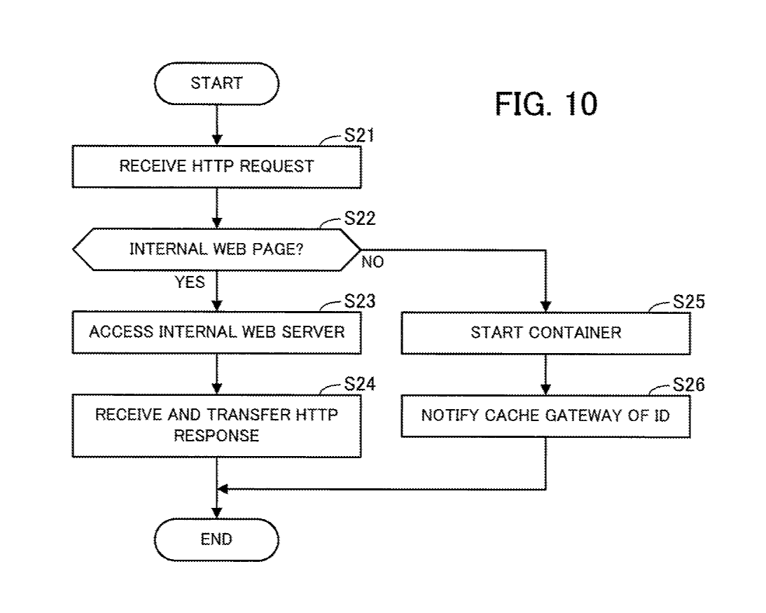

FIG. 10 is a flowchart illustrating an example of processing performed when a link to a new Web page is requested by the terminal apparatus.

[Step S21] The proxy server 110 receives an HTTP request for browsing a Web page from the browser 51 of the terminal apparatus 50.

[Step S22] The proxy server 110 extracts an URL from the received HTTP request, refers to the extracted URL, and determines whether the requested Web page is provided by the internal Web server or an external Web page. When browsing of an internal Web page is requested, the proxy server 110 performs processing in step S23. In contrast, when browsing of an external Web page is requested, the proxy server 110 transmits the received HTTP request to the container management unit 120. In this case, processing in step S25 is performed.

[Step S23] The proxy server 110 transfers the received HTTP request to the internal Web server 210 and accesses the internal Web server 210.

[Step S24] The proxy server 110 receives an HTTP response from the internal Web server and transfers the HTTP response to the browser 51 of the terminal apparatus 50. The browser 51 displays an image of the internal Web page in the Web page area 51b on the basis of the received HTTP response.

[Step S25] The container management unit 120 selects container information from the container information storage unit 140. This selection is performed as follows. For example, assuming that the user performs a log-in operation on the browsing control gateway 100 when the terminal apparatus 50 connects to the browsing control gateway 100, the container management unit 120 selects, from the container information storage unit 140, container information including user information 142 that matches user information (for example, a user ID) obtained in the log-in operation. Alternatively, the container management unit 120 determines a user group to which the user belongs on the basis of user information obtained in the log-in operation. From the container information storage unit 140, the container management unit 120 selects container information including user information 142 having the determined user group. Alternatively, from the container information storage unit 140, the container management unit 120 selects container information including user information 142 having an address of the terminal apparatus 50.

The following description assumes that the container management unit 120 has selected the container information 141a. The container management unit 120 starts a container 170 on the basis of the selected container information 141a. More specifically, the container management unit 120 temporarily ensures a user space for the container 170 on the RAM 102. The container management unit 120 expands the application programs 143, 144, 145 included in the container information 141a in the ensured user space. As a result, the application programs 143, 144, 145 are executed by using the user space, and the virtual browser 171, the screen generation unit 172, and the screen transfer control unit 173 are started.

[Step S26] The container management unit 120 notifies the cache gateway 130 of identification information of the started container 170. Consequently, the cache gateway 130 is able to exchange information with the screen transfer control unit 173 on the container 170.

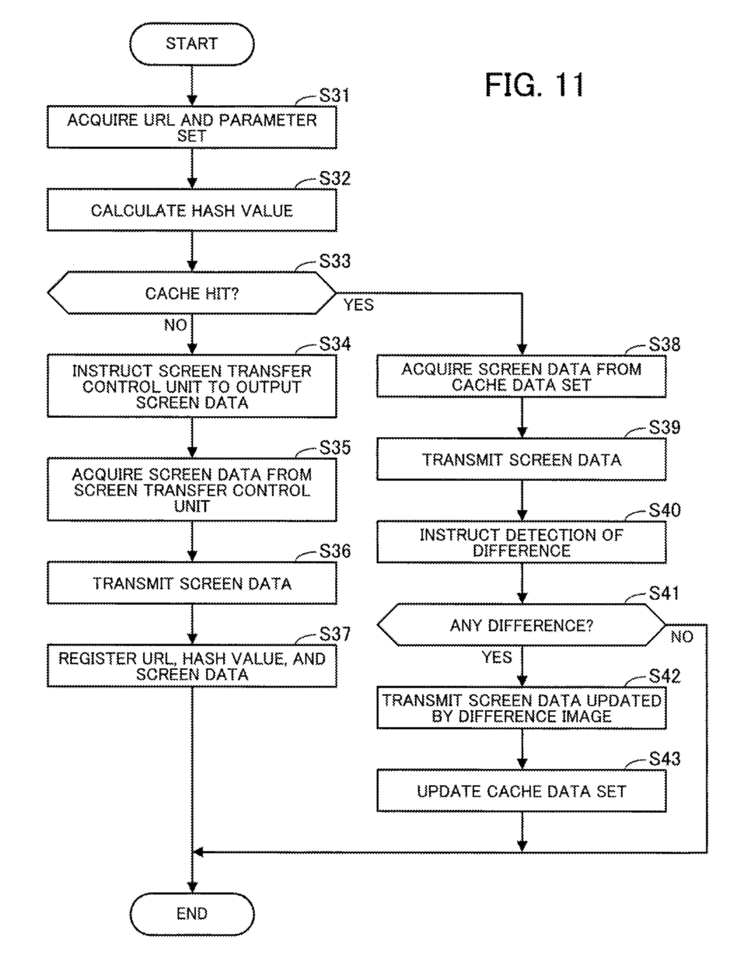

FIG. 11 illustrates a flowchart illustrating an example of processing performed by the cache gateway when a link to an external Web page is requested. The cache gateway 130 starts the processing in FIG. 11 in response to the notification in step S26 in FIG. 10.

[Step S31] The cache gateway 130 requests the screen transfer control unit 173 on the started container 170 to transmit the URL of the access-destination external Web page and the parameter set about the corresponding virtual browser 171. The cache gateway 130 acquires these items of information from the screen transfer control unit 173.

[Step S32] The cache gateway 130 calculates a hash value on the basis of the acquired parameter set.

[Step S33] The cache gateway 130 searches the cache 150 by using the acquired URL and the calculated hash value as keys. When the cache gateway 130 finds a cache data set having a matching URL and hash value (a cache hit), the cache gateway 130 performs processing in step S38. In contrast, when the cache gateway 130 does not find a cache data set having a matching URL and hash value (a cache miss), the cache gateway 130 performs processing in step S34.

[Step S34] The cache gateway 130 instructs the screen transfer control unit 173 to output Web page screen data.

[Step S35] The cache gateway 130 acquires the screen data from the screen transfer control unit 173. As this screen data, the cache gateway 130 acquires the image data in the outer frame area 171c of the virtual browser 171 and the image data in the initial display area 152b2 in the Web page area 171b.

[Step S36] The cache gateway 130 synthesizes the acquired image data, generates image data for displaying a screen in which the corresponding Web page image is included in the virtual browser 171, and transmits the generated image data to the screen transfer client 52 of the terminal apparatus 50. As a result, a screen based on the transmitted image data is displayed by the browser 51.

[Step S37] The cache gateway 130 creates a new cache data set in which the screen data acquired in step S35, the URL acquired in step S31, and the hash value calculated in step S32 are registered. The cache gateway 130 stores the created cache data set in the cache 150.

[Step S38] Assuming that the cache gateway 130 has found the cache data set 151a in step S33, the cache gateway 130 acquires screen data from the cache data set 151a. In this step, the cache gateway 130 acquires the image data in the outer frame area 171c of the virtual browser 171 and the image data in the initial display area 152b2 of the Web page area 171b.

[Step S39] The cache gateway 130 synthesizes the acquired image data, generates image data of a screen in which the corresponding Web page image is included in the virtual browser 171, and transmits the generated image data to the screen transfer client 52 of the terminal apparatus 50. As a result, a screen based on the transmitted image data is displayed by the browser 51.

[Step S40] The cache gateway 130 transmits the screen data transmitted in step S39 to the screen transfer control unit 173 and instructs the screen transfer control unit 173 to detect the difference between the screens.

[Step S41] When any difference is detected by the screen transfer control unit 173, the cache gateway 130 performs processing in step S42. Otherwise, the cache gateway 130 ends the present processing.

[Step S42] The cache gateway 130 acquires data of the difference image corresponding to the difference from the screen transfer control unit 173. The cache gateway 130 updates, of the screen data transmitted in step S39, the image data in the area corresponding to the difference image by using the data acquired from the screen transfer control unit 173 and transmits the updated screen data to the screen transfer client 52 of the terminal apparatus 50. As a result, the area of the difference image in the image displayed by the browser 51 is updated by a new image.

[Step S43] The cache gateway 130 updates the screen data registered in the cache data set 151a by using the screen data updated in step S42.

Through the processing in steps S40 to S43, for example, when a cache hit has been determined, even when the display state of the Web page has changed from the previous state, the terminal apparatus 50 is able to display the changed Web page screen. In addition, the data of the changed Web page screen is held in the cache 150.

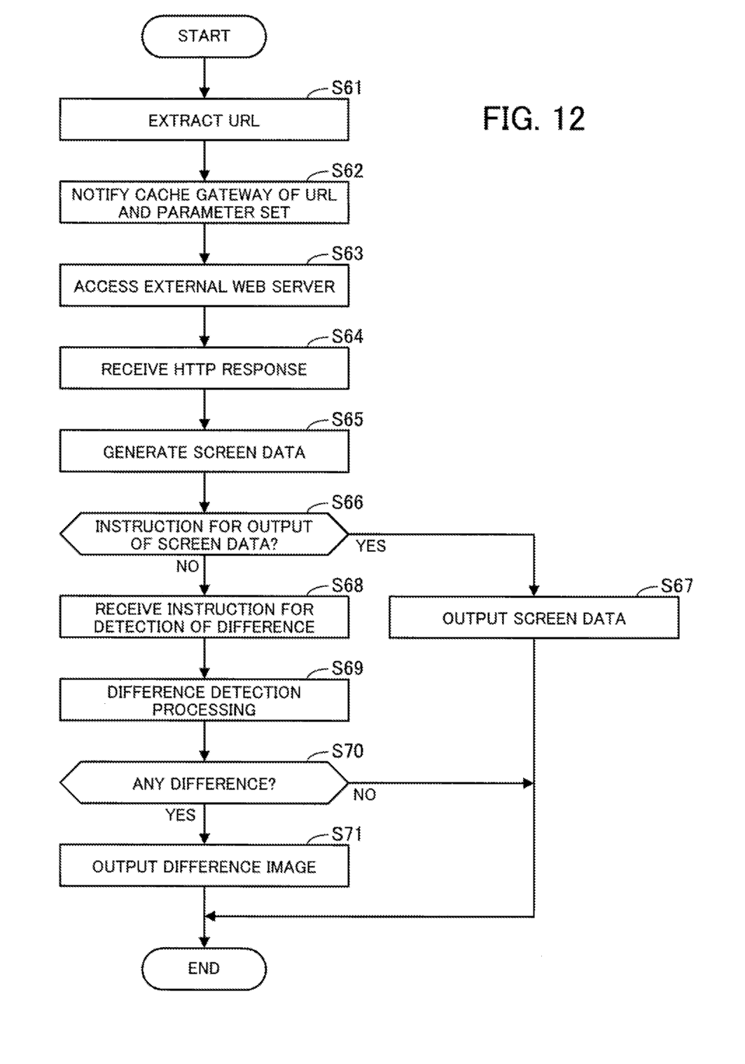

FIG. 12 is a flowchart illustrating an example of processing performed by a container started. When a container 170 is started in step S25 in FIG. 10, the processing in FIG. 12 is performed on the started container 170. In addition, the processing in FIG. 12 is performed in parallel with the processing in FIG. 11.

[Step S61] The virtual browser 171 extracts the URL from the HTTP request received from the container management unit 120.

[Step S62] In the processing in step S31 in FIG. 11, the cache gateway 130 requests the screen transfer control unit 173 to transmit the relevant URL and parameter set. The virtual browser 171 notifies the cache gateway 130 of the extracted URL and the parameter set about the corresponding virtual browser 171 via the screen transfer control unit 173.

[Step S63] The virtual browser 171 transmits the HTTP request to the external Web server 220 identified by the extracted URL and accesses the external Web server 220.

[Step S64] The virtual browser 171 receives an HTTP response transmitted by the access-destination external Web server 220.

[Step S65] The virtual browser 171 analyzes the HTTP response and instructs the screen generation unit 172 to render a screen on which the corresponding external Web page is displayed. The screen generation unit 172 renders this Web page screen on the virtual browser 171 and generates the corresponding screen data. In this step, the screen generation unit 172 generates the image data in the outer frame area 171c of the virtual browser 171 and the image data in the initial display area 152b2 in the Web page area 171b.

[Step S66] The screen transfer control unit 173 determines whether the cache gateway 130 has instructed output of the screen data. The cache gateway 130 transmits this output instruction when the cache gateway 130 performs step S34 in FIG. 11 after a cache miss is determined. When the cache gateway 130 has instructed output of the screen data, the screen transfer control unit 173 performs processing in step S67. Otherwise, the screen transfer control unit 173 performs processing in step S68.

[Step S67] The screen transfer control unit 173 outputs the screen data generated in step S65 to the cache gateway 130. In this case, the cache gateway 130 acquires the outputted screen data in step S35 in FIG. 11.

[Step S68] The screen transfer control unit 173 acquires screen data from the cache gateway 130 and receives a difference detection instruction. The cache gateway 130 transmits this instruction when performing step S40 in FIG. 11.

[Step S69] The screen transfer control unit 173 performs processing for detecting a difference area between the image based on the screen data generated in step S65 and the image based on the screen data acquired from the cache gateway 130 in step S68.

[Step S70] When the screen transfer control unit 173 detects a difference area, the screen transfer control unit 173 performs processing in step S71. Otherwise, the screen transfer control unit 173 ends the present processing.

[Step S71] The screen transfer control unit 173 outputs image data corresponding to the detected difference area and position information about the image data to the cache gateway 130. The cache gateway 130 acquires the outputted image data in step S42 in FIG. 11.

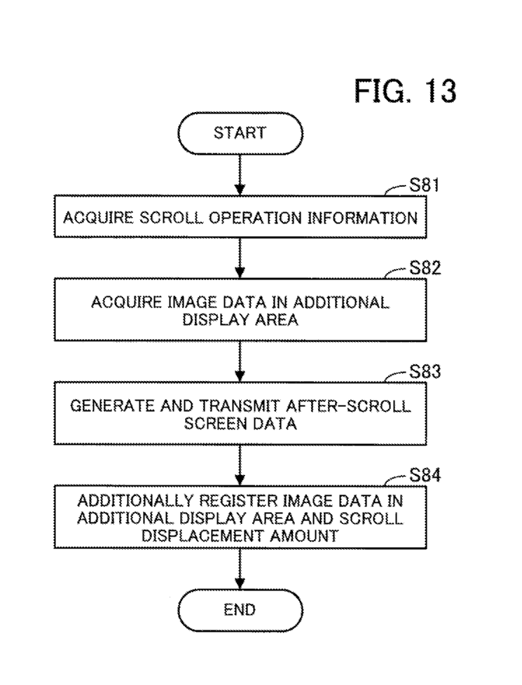

FIG. 13 is a flowchart illustrating an example of processing performed by the cache gateway when a cache miss is determined and a scroll operation is performed. The processing in FIG. 13 is performed after the processing in step S37 in FIG. 11.

[Step S81] When a scroll operation is performed in the Web page area 51b of the browser 51, the browsing control gateway 100 acquires information about the content of the scroll operation.

More specifically, the screen transfer client 52 transmits information about the position specified by the operation on the screen in the scroll operation. The cache gateway 130 receives this information and notifies the virtual browser 171 of the information via the screen transfer control unit 173. The virtual browser 171 recognizes the content of the scroll operation on the basis of the received information.

The scroll operation may be performed between when the link to the external Web page is requested in step S31 in FIG. 11 and when the processing in step S37 is completed.

[Step S82] The virtual browser 171 causes the screen generation unit 172 to render the image in the additional display area additionally displayed in the Web page area 171b by the screen displacement amount of the scroll operation. The screen generation unit 172 generates image data for displaying the image in the additional display area. The screen transfer control unit 173 outputs the generated image data and the screen displacement amount of the scroll operation to the cache gateway 130. The cache gateway 130 acquires these items of information.

[Step S83] The cache gateway 130 merges the image data acquired in step S82 to the screen data acquired in step S35 in FIG. 11. In this operation, the image data in the upper area on the screen, the image data corresponding to the displacement amount of the scroll operation, is deleted. In this way, the screen data in the Web page area 171b obtained after the scroll operation is generated. The cache gateway 130 transmits the generated screen data to the screen transfer client 52 of the terminal apparatus 50. As a result, the scrolled Web page screen is displayed in the Web page area 51b of the browser 51.

[Step S84] The cache gateway 130 registers the image data of the image in the additional display area by adding the image data to the screen data registered in the cache 150 in step S37 in FIG. 11. In addition, the cache gateway 130 registers the screen displacement amount of the scroll operation in the cache data set registered in step S37 as the scroll operation data 155.

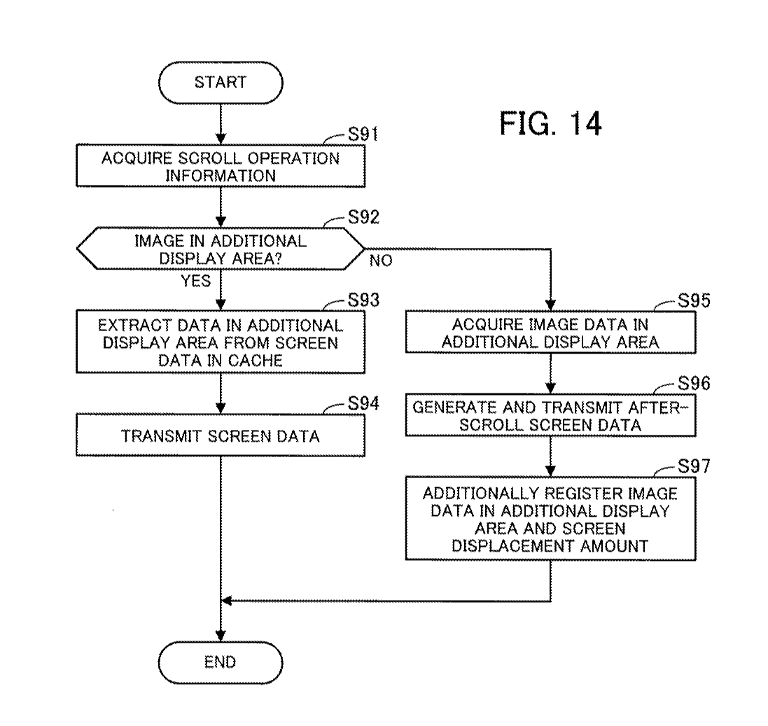

FIG. 14 is a flowchart illustrating an example of processing performed by the cache gateway when a cache hit is determined and a scroll operation is performed. This processing in FIG. 14 is performed after “No” is determined in step S41 in FIG. 11 or after the processing in step S43 is performed.

[Step S91] When a scroll operation is performed in the Web page area 51b of the browser 51, the browsing control gateway 100 acquires information about the content of the scroll operation in the same way as in step S81 in FIG. 13. The scroll operation may be performed between when the link to the external Web page is requested in step S31 in FIG. 11 and when “No” is determined in step S41 or when the processing in step S37 is completed.

[Step S92] The screen transfer control unit 173 notifies the cache gateway 130 of the screen displacement amount of the scroll operation determined by the virtual browser 171. The cache gateway 130 compares the displacement amount with the scroll operation data 155 registered in the cache data set 151a found in step S33 in FIG. 11. On the basis of the comparison result, the cache gateway 130 determines whether the image data in the additional display area additionally displayed by the displacement amount in the Web page area 171b is registered in the cache data set 151a.

When no scroll operation data 155 is registered, no image data in the additional display area is registered in the cache data set 151a. In this case, the cache gateway 130 performs processing in step S95. When the displacement amount is equal to or less than that included in the scroll operation data 155, the cache gateway 130 determines that the image data in the additional display area is registered and performs processing in step S93. In contrast, when the displacement amount is larger than that included in the scroll operation data 155, the cache gateway 130 determines that at least part of the image data in the additional display area is not registered and performs processing in step S95.

[Step S93] The cache gateway 130 extracts the image data in the additional display area from the Web page area data 152b registered in the cache data set 151a.

[Step S94] The cache gateway 130 merges the image data in the additional display area extracted from the Web page area data 152b to the screen data acquired in step S38 in FIG. 11. In this step, the image data in the upper area on the screen, the image data corresponding to the displacement amount of the scroll operation, is deleted. In this way, the screen data in the Web page area 171b obtained after the scroll operation is generated. The cache gateway 130 transmits the generated screen data to the screen transfer client 52 of the terminal apparatus 50. As a result, the scrolled Web page screen is displayed in the Web page area 51b of the browser 51.

In the above steps S93 and S94, since the cache gateway 130 generates after-scroll screen data by using the screen data registered in the cache 150 and transmits the generated screen data to the terminal apparatus 50, the terminal apparatus 50 is able to display a scrolled screen within a short time.

[Step S95] The cache gateway 130 requests the virtual browser 171 to output the image data in the additional display area via the screen transfer control unit 173. The virtual browser 171 instructs the screen generation unit 172 to render the image in the additional display area. The screen generation unit 172 generates image data of the image in the additional display area. The screen transfer control unit 173 outputs the generated image data to the cache gateway 130. The cache gateway 130 acquires these items of information.

[Step S96] The cache gateway 130 merges the image data acquired in step S95 to the screen data acquired in step S38 in FIG. 11. In this operation, the image data in the upper area on the screen, the image data corresponding to the displacement amount of the scroll operation, is deleted. In this way, the screen data in the Web page area 171b obtained after the scroll operation is generated. The cache gateway 130 transmits the generated screen data to the screen transfer client 52 of the terminal apparatus 50. As a result, the scrolled Web page screen is displayed in the Web page area 51b of the browser 51.

[Step S97] The cache gateway 130 registers the image data of the image in the additional display area by adding the image data to the Web page area data 152b registered in the cache data set 151a. In addition, the cache gateway 130 registers the screen displacement amount of the scroll operation in the cache data set 151a as the scroll operation data 155.

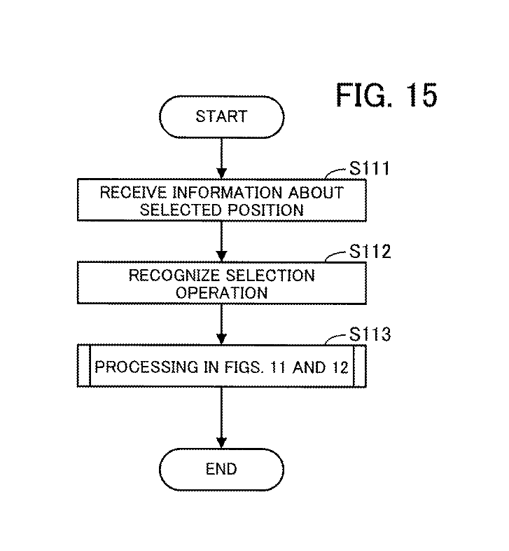

FIG. 15 is a flowchart illustrating an example of processing performed when a link to another external Web page is requested on an external Web page.

[Step S111] The following example assumes that a user has selected a link image on an external Web page displayed in the Web page area 51b of the browser 51. The screen transfer client 52 transmits information about the selected position to the browsing control gateway 100. The cache gateway 130 of the browsing control gateway 100 receives the information about the selected position.

[Step S112] The cache gateway 130 notifies the corresponding virtual browser 171 of the information about the selected position via the screen transfer control unit 173. The virtual browser 171 refers to the information about the selected position and recognizes that the link image has been selected.

[Step S113] The cache gateway 130 performs the processing in FIG. 11, and the container 170 performs the processing in FIG. 12. In step S61 in FIG. 12, the virtual browser 171 extracts the URL corresponding to the selected link image.

[Variation of Second Embodiment]

The Web browsing system according to the second embodiment may be changed as follows. Hereinafter, a variation of the second embodiment will be described by using the same reference characters in FIG. 5.

In the above second embodiment, when a user requests browsing of an external Web page, a container started is selected on the basis of any one of the user, a user group, and an address of the terminal apparatus 50. In contrast, in this variation, a plurality of items of container information, each of which includes a different parameter set for the corresponding virtual browser program, are registered in advance in the container information storage unit 140. The container management unit 120 selects container information including a hash value based on a registered parameter set, the hash value matching that registered in the cache 150. The container management unit 120 starts a container 170 on the basis of the selected container information. In this way, the container management unit 120 is able to start a container 170 corresponding to a cache hit.

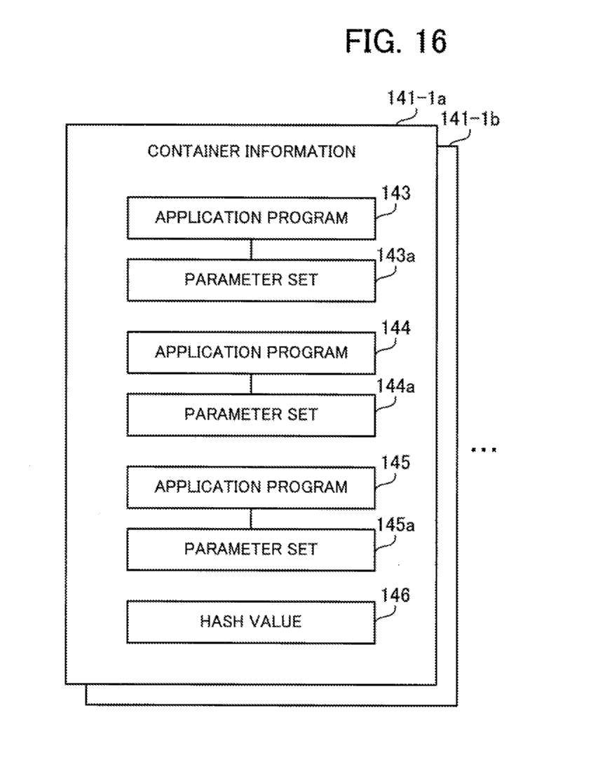

FIG. 16 illustrates data examples stored in the container information storage unit. The container information storage unit 140 holds container information 141-1a, 141-1b, etc. for starting the respective containers 170. As in FIG. 6, the items of container information 141-1a, 141-1b, etc. each includes application programs 143, 144, and 145, and parameter sets 143a, 144a, and 145a. However, the items of container information 141-la, 141-1b, etc. each include a different parameter set about the corresponding virtual browser program.

In addition, the items of container information 141-1a, 141-1b, etc. each include a hash value 146 in place of the user information 142. An individual hash value 146 is calculated on the basis of the parameter set about the corresponding virtual browser program. The items of container information 141-1a, 141-1b, etc. each include a different hash value 146.

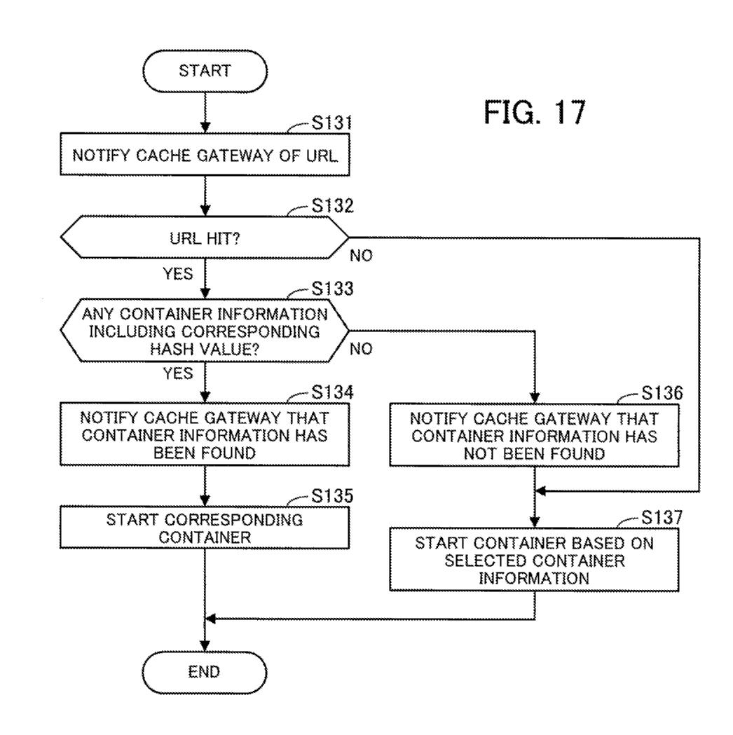

FIG. 17 is a flowchart illustrating an example of processing performed when a link to an external Web page is requested. After the processing in steps S21 and S22 in FIG. 10 is performed, namely, after the proxy server 110 determines that browsing of an external Web page has been requested and transmits the HTTP request to the container management unit 120, processing in FIG. 17 is started.

[Step S131] The container management unit 120 extracts the URL from the HTTP request and notifies the cache gateway 130 of the URL.

[Step S132] The cache gateway 130 searches the cache 150 by using the URL as a key. When the cache gateway 130 finds a cache data set including the URL (a URL hit), the cache gateway 130 performs processing in step S133. In contrast, when the cache gateway 130 does not find a cache data set including the URL, the cache gateway 130 notifies the container management unit 120 of the absence of the matching cache data set and starts processing in step S34 and the steps subsequent thereto in FIG. 11. In addition, the container management unit 120 performs processing in step S137.

[Step S133] The cache gateway 130 reads a hash value from the cache data set found in step S132 and notifies the container management unit 120 of the hash value. The container management unit 120 searches the container information storage unit 140 by using the hash value as a key. When container information including the hash value is found, the container management unit 120 performs processing in step S134. Otherwise, the container management unit 120 performs processing in step S136.

[Step S134] The container management unit 120 notifies the cache gateway 130 that container information including the hash value has been found. In this case, a cache hit is determined, and a cache data set that needs to be used is determined. The cache gateway 130 starts step S38 and the steps subsequent thereto in FIG. 11 by using the determined cache data set.

[Step S135] The container management unit 120 selects container information found in step S133 and starts a container 170 based on the selected container information. As a result, the processing in FIG. 12 is started with the started container 170. However, the processing in step S62 in FIG. 12 is skipped.

[Step S136] The container management unit 120 notifies the cache gateway 130 that the container management unit 120 does not find container information including the hash value of which the container management unit 120 has been notified. In this case, a cache miss is determined, and the cache gateway 130 starts the processing in step S34 and the steps subsequent thereto in FIG. 11.

[Step S137] The container management unit 120 selects any one of the items of container information registered in the container information storage unit 140 and starts a container 170 on the basis of the selected container information. In this way, the processing in FIG. 12 is started with the started container 170.

According to the above variation, when there is a container corresponding to a cache hit (namely, a container able to display the requested Web page screen with an accurate layout), the container management unit 120 starts the container. In this way, the browsing control gateway 100 is able to transfer Web page screen data to the terminal apparatus 50 by using screen data registered in the cache 150.

Processing functions of the apparatuses described in the above embodiments (for example, the image transfer apparatus 1 and the browsing control gateway 100) may be realized by a computer. In this case, the processing functions are realized on the computer by providing the computer with a program in which processing contents of functions of an individual apparatus are written and causing the computer to execute the program. The program in which the processing contents are written may be stored in a computer-readable storage medium. Examples of the computer-readable storage medium include a magnetic storage device, an optical disc, magneto-optical storage medium, and a semiconductor memory. Example of the magnetic storage device include an HDD, a flexible disk (FD), and a magnetic tape. Examples of the optical disc include a digital versatile disc (DVD), a DVD-RAM, a compact disc-read only memory (CD-ROM), and a CD-Recordable (R)/ReWritable (RW). Examples of the magneto-optical storage medium include a magneto-optical disk (MO).

One way to distribute the program is to sell portable storage media such as DVDs or CD-ROMs in which the program is recorded. The program may be stored in a storage device of a server computer and forwarded to other computers from the server computer via a network.

For example, a computer that executes the program stores the program stored in a portable storage medium or forwarded from the server computer in a storage device of the computer. Next, the computer reads the program from its own storage device and executes processing in accordance with the program. The computer may directly read the program from the portable storage medium and perform processing in accordance with the program. Each time a computer receives a program from a server computer connected thereto via a network computer, the computer may perform processing in accordance with the sequentially received program.

In one aspect, a Web page is accurately displayed on a terminal apparatus within a short time.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. An image transfer apparatus comprising:
a memory configured to hold at least one first data group, each of which includes first image data of a screen of a first Web page displayed on a virtual browser, a first address for identifying the first Web page, and first setting information about display of the virtual browser performed when the first image data is generated; and
a processor configured to search the at least one first data group stored in the memory for a second data group including a first address matching a second address for identifying a second Web page for which a browse request has been transmitted by a terminal apparatus and first setting information matching second setting information about a virtual browser corresponding to the browse request for the second Web page, perform first processing when the second data group does not exist, and perform second processing when the second data group exists,
wherein, in the first processing, the processor receives Web page information for displaying the second Web page from a server apparatus specified by the second address, generates second image data of a screen of the second Web page displayed on the virtual browser on the basis of the Web page information, and transmits the second image data to the terminal apparatus, and
wherein, in the second processing, the processor reads first image data included in the second data group from the memory and transmits the first image data to the terminal apparatus.

2. The image transfer apparatus according to claim 1,
wherein the first setting information is a first hash value calculated based on a first setting value about display of the virtual browser performed when the first image data is generated, and
wherein, in the search, the processor searches the at least one first data group for a second data group including a first address matching the second address and a first hash value matching a second hash value calculated based on a second setting value about the virtual browser corresponding to the browse request for the second Web page.

3. The image transfer apparatus according to claim 2,
wherein the first image data represents a screen of the virtual browser displayed based on the first setting information when the first image data is generated and a screen of the first Web page displayed inside the screen of the virtual browser.

4. The image transfer apparatus according to claim 2,
wherein the memory further holds a plurality of items of memory usage information each of which corresponds to a memory space temporarily ensured on the memory for performing processing of a corresponding virtual browser and includes different first setting information,
wherein the first hash value is calculated based on the first setting information included in first memory usage information selected from the plurality of items of memory usage information when processing of the virtual browser for generating the first image data is performed, and
wherein, when browsing of the second Web page is requested by the terminal apparatus, the processor ensures a memory space on the memory based on second memory usage information selected from the plurality of items of memory usage information and calculates the second hash value based on the first setting information included in the second memory usage information.

5. The image transfer apparatus according to claim 4, wherein each of the plurality of items of memory usage information is generated per user or user group requesting browsing of a Web page.

6. The image transfer apparatus according to claim 4,
wherein each of the plurality of items of memory usage information includes different first setting information and a third hash value calculated based on the first setting information registered in the corresponding memory usage information,
wherein, when browsing of the second Web page is requested by the terminal apparatus, the processor searches the at least one first data group stored in the memory for a third data group including a first address matching the second address, and
wherein, when the third data group exists, the processor selects, from the plurality of items of memory usage information, memory usage information including a third hash value matching the first hash value included in the third data group as the second memory usage information.

7. The image transfer apparatus according to claim 1,
wherein first image data included in at least one of the at least one first data group includes third image data of a screen displayed when the first Web page is initially displayed on the virtual browser on the screen of the first Web page and fourth image data of a screen additionally displayed on the virtual browser in accordance with a scroll operation on the screen of the first Web page, and
wherein, when the second data group including the fourth image data exists and when a scroll operation on the second Web page is received from the terminal apparatus, the processor extracts image data of a screen displayed on the virtual browser in accordance with the received scroll operation from the third and fourth image data included in the second data group and transmits the extracted image data to the terminal apparatus.

8. The image transfer apparatus according to claim 1,
wherein, when the second data group exists, the processor performs third processing for receiving Web page information from a server apparatus and generating second image data based on the Web page information in parallel with the second processing,
wherein the processor extracts difference between the first image data included in the second data group and the second image data,
wherein, when the difference is extracted, the processor changes image data to be transmitted to the terminal apparatus from the first image data included in the second data group to the second image data and updates the first image data included in the second data group by using the second image data.

9. The image transfer apparatus according to claim 1, wherein the first setting information includes information for determining whether to display an individual image in an area other than a Web page display area on the screen of the corresponding virtual browser.

10. The image transfer apparatus according to claim 1, wherein the first setting information includes version information about a virtual browser program that realizes processing of the corresponding virtual browser.

11. An image transfer method comprising:
referring to, by a computer, a memory which holds at least one first data group, each of which includes first image data of a screen of a first Web page displayed on a virtual browser, a first address for identifying the first Web page, and first setting information about display of the virtual browser performed when the first image data is generated;
searching, by the computer, the at least one first data group stored in the memory for a second data group including a first address matching a second address for identifying a second Web page for which a browse request has been transmitted by a terminal apparatus and first setting information matching second setting information about a virtual browser corresponding to the browse request for the second Web page;
performing, by the computer, when the second data group does not exist, first processing for receiving Web page information for displaying the second Web page from a server apparatus specified by the second address, generating second image data of a screen of the second Web page displayed on the virtual browser on the basis of the Web page information, and transmitting the second image data to the terminal apparatus, and
performing, by the computer, when the second data group exists, second processing for reading first image data included in the second data group from the memory and transmitting the first image data to the terminal apparatus.
